(19) United States
(12) Patent Application Publication
(10) Pub. No.: US 2007/0150607 A1
(43) Pub. Date: Jun. 28, 2007

(54) SYSTEMS AND METHODS FOR AMPLIFING SOCIAL DYNAMICS USING MOBILE DEVICES

(75) Inventors: Edward P. Flinchem, Seattle, WA (US); William L. Valenti, Seattle, WA (US); Maxwell J. Wells, Seattle, WA (US)

Correspondence Address: BLACK LOWE & GRAHAM, PLLC, 701 FIFTH AVENUE, SUITE 4800, SEATTLE, WA, 98104, US

(73) Assignee: MELODEO INC., Seattle, WA (US)

(21) Appl. No.: 11/614,833

(22) Filed: Dec. 21, 2006

Related U.S. Application Data
(60) Provisional application No. 60/752,538, filed on Dec. 21, 2005.

(51) Int. Cl. G06F 15/16

(52) U.S. Cl. 709/228

(57) ABSTRACT

Systems and methods for allowing communication between two or more proximate mobile computing devices. In one method a first device detects the presence of a second device. A signal is sent by a first device for requesting a comparison of the lists of media files. The signal can be sent to a second device (or to a server over a wireless network) and may include the list of media files associated with the first device. The second device sends a list of media files to the first device after receiving the signal. An alert is outputted if a list of media files associated with the first device is determined to be comparable to a list of media files associated with the second device based on one or more predefined parameters.

### PRIORITY CLAIM

This invention claims the benefit of U.S. Provisional Application Ser. No. 60/752,538 filed Dec. 21, 2005, the contents of which are hereby incorporated by reference.

### FIELD OF THE INVENTION

This invention relates generally to mobile communication systems and, more specifically, to proximity communication with mobile devices.

### BACKGROUND OF THE INVENTION

Many systems exist for enabling the interaction of people. These generally include formal settings that the participants have paid money to join. However, there does not exist any effective systems that facilitate communication outside of these formal settings.

Therefore, there exists a need for facilitating personal connections in public forums.

### SUMMARY OF THE INVENTION

The present invention provides systems and methods for allowing communication between two or more proximate mobile computing devices. An example method detects the presence of a second mobile computing device at a first mobile computing device, receives at least one of a portion of a list of media files or user information from at least one of the second mobile computing device or a server over a wireless network, and determines if there exists a match between the first mobile computing device and the second mobile computing device based on the received at least one of the portion of the list of media files or the user information from the second mobile computing device and at least one of a portion of a list of media files or user preference information associated with the first mobile computing device. An alert is outputted, if a match is determined.

### BRIEF DESCRIPTION OF THE DRAWINGS

Preferred and alternative embodiments of the present invention are described in detail below with reference to the following drawings:

FIGS. 1 and 2 are schematic diagrams of example systems formed in accordance with embodiments of the present invention; and

FIGS. 3 and 4 are flowcharts of example methods performed by the systems shown in FIGS. 1 and 2.

### DETAILED DESCRIPTION OF THE PREFERRED EMBODIMENT

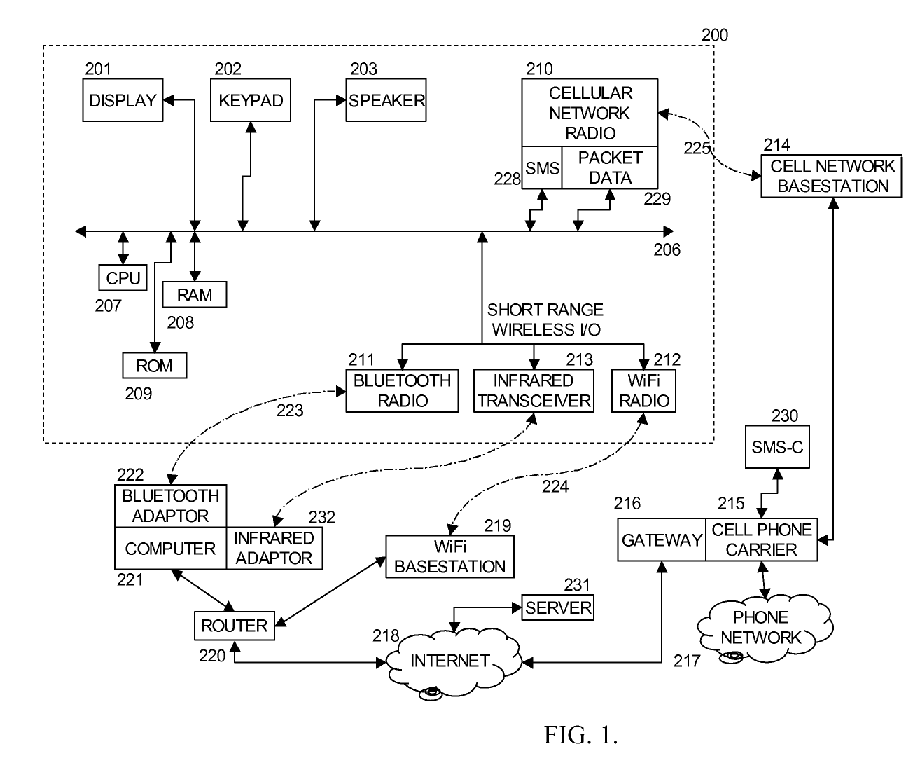

FIG. 1 shows a user device 200, such as a mobile phone, having a processor 207, random access memory 208, persistent memory 209 (which could be rewriteable FLASH memory), a display 201, a keypad 202, one or more speakers 203, and a cellular network radio data communication component 210. The radio component 210 allows data communications with a public or private data network 218 such as the Internet via cellular wireless voice and data network basestations 214, associated mobile phone carrier 215 and a gateway 216. The radio component 210 sends and receives a variety of packet data 229 according to a predefined protocol (UDP, TCP, SMTP, HTTP, etc) through the data network 218.

Via network 217, the device 200 may communicate to other mobile devices such as computers 221 and servers 231 via the network 218. The radio 210 sends and receives both Short Message Service (SMS) messages 228 through the phone network 217 to other devices identified by their phone numbers and sends a variety of packet data 229 through the data network 218 via a predefined protocol (UDP, TCP, SMTP, HTTP, etc).

In one embodiment, at least one of a variety of short-range wireless communication interfaces, including Bluetooth radio 211, Wireless Fidelity (WiFi) radio 212, and an infrared transceiver 213. The Bluetooth radio 211 allows communication via a short-range microwave link 223 (10s of meters) with Bluetooth adaptors 222 connected to computers 221 and by extension through them via a router 220 to other devices on the public or private data network 218. The Bluetooth radio 211 is able also communicate directly to other similarly enabled mobile phones

WiFi radio 212 provides communication via short-range microwave links 224 (10s-100s of meters) WiFi basestations 219 connected via the router 220, which may be incorporated into the WiFi basestations 219, to the public or private data network 218. The WiFi radio 212 allows communication directly to other similarly enabled mobile phones.

The infrared transceiver 213 allows communication with infrared adaptors 232 connected to computers 221 and by extension through them via the router 220 to other devices on the public or private data network 218. The infrared transceiver 213 also allows communication directly to other similarly enabled mobile phones.

The server complex 231 enables: (a) storage and comparison of content files stored on user devices and user content preferences; (b) receiving of signals from user devices; (c) alerting user devices to presence of other user devices with similar content or content preferences; and (d) passing messages anonymously between user devices.

Connected to the cell phone carrier 215 is a short message service center 230 (SMS-C) that enables transmission of messages between phones routed by their phone number and between the server complex 231 and phones.

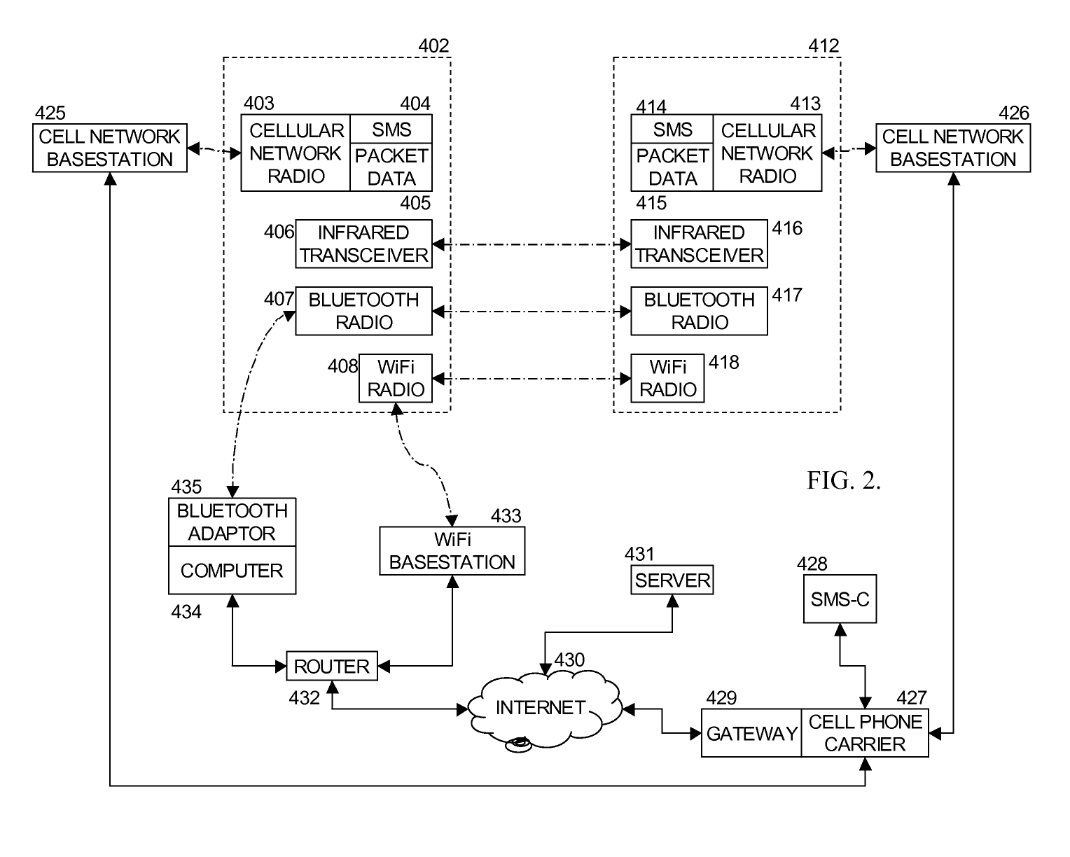

As shown in FIG. 2, devices 402 and 412 (e.g. mobile phones) are equipped with cellular network radios 403, 413 and are connected to SMS 404, 414 or packet data 405, 415 components. The radios 403, 413 communicate with their associated mobile phone carrier 427 and onward through a gateway 429 to a public or private data network 430 such as the Internet via a cellular wireless voice and data network basestations 425, 426. The devices 402, 412 communicate to each other and to other mobile phones and other devices such as computer 434 and a server 431 via the data network 430.

The radios 403, 413 send and receive both Short Message Service (SMS) messages 404, 414 through the phone carriers 427 to other phones identified by their phone numbers and send a variety of packet data 405, 415 according to a protocol (such as UDP, TCP, SMTP, HTTP, etc) through the data network 430.

In one embodiment, the devices 402, 412 include at least one of a variety of short-range wireless communication interfaces, including Bluetooth radios 407, 417, WiFi radios 408, 418, and infrared transceivers 406, 416. The Bluetooth radio 407 may communicate with Bluetooth adaptors 435 connected to computers 434 and by extension through them via a router 432 to other devices on the public or private data network 430. The Bluetooth radio 407 is also able to communicate directly to other similarly enabled devices.

WiFi radio 408 is able to communicate with WiFi basestations 433 connected via the router 432 (which may be incorporated into 433 to the public or private data network 430. WiFi radio 408 may also communicate directly to other similarly enabled devices 412.

The infrared transceiver 406 may communicate with infrared adaptors (not shown) connected to computers and by extension through them via the router 432 to other devices on the public or private data network 430. The infrared transceiver 406 may also communicate directly to other similarly enabled devices.

Connected to the data network 430 is the server complex 431 that enables: (a) storage and comparison of content files stored on user devices 402, 412 and user content preferences; (b) receiving signals from user devices; (c) alerting user devices to presence of other user devices with similar content or content preferences; and (d) passing messages anonymously between user devices. Connected to the cell phone carrier 427 is a short message service center 428 (SMS-C) enabling transmission of messages between phones routed by their phone number.

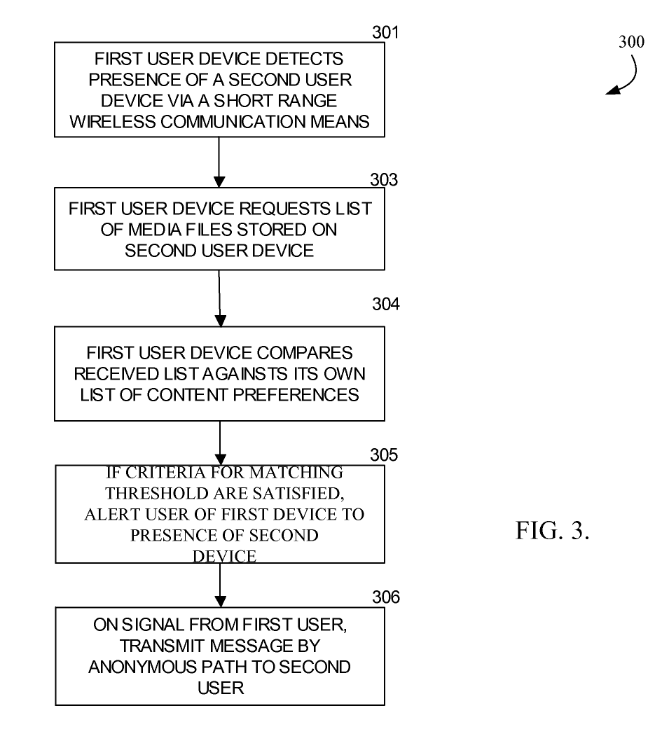

FIG. 3 shows a flowchart of an example process 300 performed by the system shown in FIGS. 1 or 2. At block 301, the first user device 402 detects presence of the second user device 412 via a short-range wireless communication means. At block 303, the first user device 402 requests a list of media files stored on the second user device 412. At block 304, the first user device 402 receives the requested list of media files from the second user device 412 and compares the received list against its own list of content preferences. A comparison between the list of media files may also be performed.

Example of content preferences include music genres, favorite artists (artists most often played, artists responsible for largest number of stored files, artists responsible for highest dollar value of content owned or streamed, etc.), favorite movie director, favorite film genre, list of media bookmarked for future purchase, data on media streamed to user device, or any other information that relates to stored or desired media.

This could be performed by a key word or similar type of search. Various different aspects of the list of media files may be compared, such as artist or song, or metadata, such as musical genre. At block 305, if criteria for matching threshold are satisfied, alert user of first device to presence of second device. This alert might come in the form of a similarities score or the alert may only be generated if the number of similar content matches exceeds a threshold amount. At block 306, on signal from the first use 402, a message is transmitted by an anonymous path to the second user device 412.

In another embodiment, when a device senses a proximate device (a device within a certain range as determined by signal strength or exchanged location information), the user device sends a request to the server to perform a comparison of the user's play list to a play list of the proximate device as determined by an identifier supplied to the user's device from the proximate device.

The user device includes one or more parameters (user preferences) that define whether the user device will provide access to its list of media files. The parameters may be set or adjusted by the authorized user of the user device. Example parameters include, but are not limited to, date, time, threshold relating to the comparison between the resident list and the list associated with the proximate user device, or age or sex of the registered user of the proximate user device. In another embodiment, parameters are stored on the server.

For example, during a busy day Adam attended several meetings, a business lunch, and a cultural event. At the end of the day, he receives a message on his user device from an anonymous person informing him of eight musical recommendations that includes a new Nora Jones track. He listens to the new Nora Jones track. He opts to purchase the track and at the same time sends an anonymous thank you to the anonymous person from whom he got the recommendation. With the thank you he includes a personal message. The next day, while listening to the track again he receives a message from Eve, the anonymous person, who was sitting in the row behind him at the cultural event the day before. The message may include information that the anonymous person desires to send.

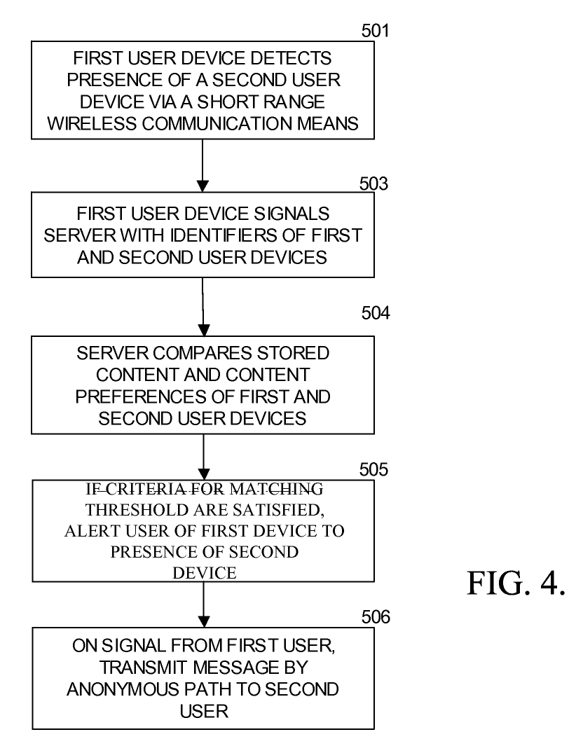

FIG. 4 shows a flowchart of another example process performed by the system shown in FIGS. 1 or 2. First, a block 501, the user device detects presence of a second user device via a short range wireless communication means. At block 503, the first user device signals the server with identifiers of first and second user devices. Next, at block 504, the server compares stored content and content preferences of the first and second user devices based on the received identifiers. At block 505, if criteria for matching threshold are satisfied, alert user of first device to presence of second device. At block 506, on signal from first user, a message is transmitted by anonymous path to the second user device.

In another embodiment, a parameter for determining if a match occurs or does not occur may be one that denies a match if a condition is met. For example, if a parameter of the first user device indicates that they hate rap, then a match will be denied if the list of media files includes rap or a threshold amount of rap.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for allowing communication between two or more proximate mobile computing devices, the method comprising:
at a first mobile computing device, detecting the presence of a second mobile computing device;
receiving at least one of a portion of a list of media files or user information from at least one of the second mobile computing device or a server over a wireless network;
determining if there exists a match between the first mobile computing device and the second mobile computing device based on the received at least one of the portion of the list of media files or the user information from the second mobile computing device and at least one of a portion of a list of media files or user preference information associated with the first mobile computing device; and
outputting an alert, if a match is determined.

2. The method of claim 1, wherein the mobile computing devices include cellular phones.

3. The method of claim 2, further comprising sending a signal to the second mobile computing device, wherein receiving includes receiving at least one of a portion of a list of media files or user information from the second mobile computing device based on the sent signal.

4. The method of claim 1, wherein the received user information includes an identification signal associated with the second mobile computing device, further comprising:
sending a signal to the server over the wireless network, the signal includes at least one of the received identification signal associated with the second mobile computing device and an identification signal associated with the first mobile computing device,
wherein determining is performed at the server based on the sent signal.

5. The method of claim 4, wherein determining includes sending a signal to at least one of the first or second mobile computing devices if the server determined a match exists.

6. The method of claim 1, wherein the user preference information includes at least one of an age preference, a sex preference, or a media content preference.

7. The method of claim 1, wherein the user preference information includes a similarity threshold between the lists of media files.

8. A first mobile computing device for allowing communication between other second mobile computing devices, the first mobile computing device comprising:
memory for storing at least one of a list of media files or user preference information;
one or more wireless communication components; and
a processor in data communication with the memory and the one or more wireless communication components, the processor comprising:
a first component for detecting the presence of a second mobile computing device and receiving at least one of a portion of a list of media files or user information associated with the second mobile computing device from at least one of the second mobile computing device or a server over a wireless network;
a second component for determining if there exists a match between the first mobile computing device and the second mobile computing device based on the received at least one of the portion of the list of media files or the user information from the second mobile computing device and at least one of a portion of a list of media files or user preference information associated with the first mobile computing device; and
a third component for outputting an alert, if a match is determined.

9. The device of claim 8, wherein the mobile computing devices include cellular phones.

10. The device of claim 9, further the processor sends a signal to the second mobile computing device, wherein the processor receives at least one of a portion of a list of media files or user information from the second mobile computing device based on the sent signal.

11. The device of claim 8, wherein the received user information includes an identification signal associated with the second mobile computing device, wherein the processor sends a signal to the server over the wireless network, the signal includes at least one of the received identification signal associated with the second mobile computing device and an identification signal associated with the first mobile computing device, wherein the server determines if there exists a match between the first mobile computing device and the second mobile computing device based on the received at least one of the portion of the list of media files or the user information from the second mobile computing device and at least one of a portion of a list of media files or user preference information associated with the first mobile computing device.

12. The device of claim 11, wherein the server sends a signal to at least one of the first or second mobile computing devices if the server determined a match exists.

13. The device of claim 8, wherein the user preference information includes at least one of an age preference, a sex preference, or a media content preference.

14. The device of claim 8, wherein the user preference information includes a similarity threshold between the lists of media files.
